(19) United States
(12) Patent Application Publication
(10) Pub. No.: US 2007/0124313 A1
(43) Pub. Date: May 31, 2007

(54) Method and apparatus for secure digital content distribution

(76) Inventors: Soo Hyung Kim, Daejeon-city (KR); Jae Seung Lee, Seoul (KR); Ki Young Moon, Daejeon-city (KR); Kyo Il Chung, Daejeon-city (KR); Sung Won Sohn, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/604,516

(22) Filed: Nov. 27, 2006

(30) Foreign Application Priority Data
Nov. 26, 2005 (KR) 10-2005-0113846

(51) Int. Cl. G06F 17/30

(52) U.S. Cl. 707/10

(57) ABSTRACT

Provided are a method and apparatus for securely distributing digital content. According to the method and apparatus, content is securely transmitted to users who have a right of use content regardless of the reliability of a content distributor, thereby allowing the users to efficiently use content. For example, even if an unauthorized third party changes a list of content users by deleting a user who has a right to use content from the list or adding a user who has no right to use content to the list, such an unauthorized change can be easily detected in real time, thereby securely protecting the list. Accordingly, it is possible to securely distribute and use digital content regardless of a content distributor.

### CROSS-REFERENCE TO RELATED PATENT APPLICATIONS

This application claims the priority of Korean Patent Application No. 10-2005-113846, filed on Nov. 26, 2005, in the Korean Intellectual Property Office, the disclosure of which is incorporated herein in its entirety by reference.

### BACKGROUND OF THE INVENTION

1. Field of the Invention

The present invention relates to security, and more particularly, to a method and apparatus for secure digital content distribution, whereby a list of users who have a right of use of digital content can be securely and efficiently managed, users can access encrypted content, available information is securely distributed to users, and users' accesses to content can be more precisely controlled.

2. Description of the Related Art

Development of technologies of digitalizing content significantly increases commercial use of content. In particular, since services of music, video, and games having various formats are provided via mobile terminals in the field of mobile communications, users can use content via their mobile terminals anywhere at any time. To activate the use of content, a technology of stably and fast transmitting content to a user's terminal, and Digital Rights Management (DRM) of allowing only users who acquire a right of use of the content by purchasing the content, for example, to use the content are needed. However, such technologies need to further be improved.

Methods of protecting digital content are largely classified into two methods. One of them is a method of accessing content by using hardware. That is, encrypted content is decrypted by using intrinsic hardware information regarding a terminal of a specific user who acquires a right of use of content, the intrinsic hardware information being unique information that cannot be copied, thereby allowing the content to be used in a hardware device of the specific user. This method is advantageous in that a content user can be easily identified since the intrinsic hardware information of the content user is difficult to be changed or copied. However, this method has problems caused by hardware exchanges due to hardware malfunctions or aging, or expensive costs for additional hardware installation.

The other method is a method of encrypting content by using a specific key and allowing only a device of a user who has the key to decode the encrypted content. This method provides a solution to the problems of the former method, but distribution of a key used to decode content is a very important issue in this case. A key is also digitized information and thus can be easily copied. To solve this problem, a public key infrastructure (PKI) is used, or additional security technologies, such as user authentication via online, are needed.

The prior art using the two methods is generally based on an assumption that a content distributor wins complete confidence from both a content provider and a content user. In general, when content is distributed to a large scale of users, a content provider does not transmit the content directly to the users, but the content provider asks a content distributor who holds a large-scale network infrastructure to transmit the content to the users. In particular, easy content accessibility is required for a user who desires to receive a content service via a mobile telecommunication terminal via a mobile telecommunication network, and thus, the user generally accesses and uses content registered with a system a mobile telecommunication service business body. However, in this case, the content is likely to be exposed to the mobile telecommunication service business body. In particular, if the content must be secretly exchanged between the content provider and the content user, it may be dangerous since the content distributor would access the content without permission.

For example, in many cases, for easy management of content, a content provider entrusts a mobile telecommunication business body that is a content distributor with full power of allocating a right of use of the content to users. In this case, the mobile telecommunication business body may infringe security matters or secrets to be kept only between the content provider and the content user without permission. If a very high-level security is provided for the content or the content is encrypted at a very high level so as to prevent this problem, the content user may experience inconvenience in using the content.

### SUMMARY OF THE INVENTION

The present invention provides a method and apparatus for secure digital content distribution, whereby a content distributor cannot change a list of users who have a right of use of content from a content provider without a help of the content provider, a content user can efficiently use encrypted content only with a help of the content distributor without contacting the content provider, and the content distributor cannot read or change the content only based on information received from the content provider.

According to an aspect of the present invention, there is provided a method of securely distributing digital content, the method comprising giving a right of use of the content to a content user by providing the user with information which contains an initial value for encrypting or decrypting the content; generating data which includes a list of users who have a right of use of the content and information guaranteeing the integrity of the list; when the content user request the content, determining whether the content user is an authorized user who has a right of use of the content, based on the list and the information guaranteeing the integrity of the list; and when it is determined that the content user is an authorized user, providing the content user with encrypted content and information for accessing the encrypted content.

According to another aspect of the present invention, there is provided a method of securely distributing digital content, the method comprising (a) a content provider providing a content user with a right of use of the content by transmitting information containing an initial value for encrypting or decrypting the content to the content user; (b) the content provider generating data which contains a list of users who have a right of use of the content and information guaranteeing the integrity of the list, and transmitting the data to the content distributor; (c) when the content user requests the content, the content distributor determining whether the content user is an authorized user who has a right of use of the content, based on the list and the information guaranteeing the list; and (d) when it is determined that the content user is an authorized user, the content distributor transmitting information for accessing encrypted content to the content user, the information being registered with the content distributor by the content provider.

During (a), a right of use of the content may be given to the content user by providing the content user with a first function for generating a key to be used to encrypt or decrypt the content, a second function for securely managing a membership list of the users, an initial value to be input to the first function, and a public key of a content provider.

The first function may be a one-way hash function, and the second function may be a one-way hash function that determines output values regardless of an order in which input values are input.

The initial value may be determined according to hardware information regarding a terminal that the content user uses to use the content.

The information generated in (b) may include the list of the users who have a right of use of the content; data needed to generate a decryption key which is used to decrypt the content and transmitted to an individual user; usage control data specifying a time limit for the content; and digital signature information guaranteeing that the list of the users is not changed by a malicious attacker.

During (c), whether the content user who requests the content has a right of use of the content may be determined based on the list of the content users, and whether the determination result is obtained based on the list of the users may be determined using the information guaranteeing the integrity of the list.

The information transmitted in (d) may comprises the encrypted content that the content user requests; data needed to generate a decryption key for decrypting the content; data specifying constraints on use of the content; and data containing unique information of the content user.

The method may further comprise (e) generating the decryption key for decrypting the encrypted content in a terminal, which corresponds to the unique information of the content user, of the content user based on the received information and the initial value for encrypting or decrypting the content, decrypting the encrypted content, and allowing the content user to use the decrypted content within a range of the right of use of the content given to the content user.

During (e), the decryption key may be generated by using the received data needed to generate the key for decrypting the encrypted content, and the content may be provided to the content user by using the decryption key and the encrypted content according to the constraints within the range of the right of use of the content.

During (e), only when the terminal of the content user corresponds to the unique number of the content user, the decryption key may be generated, and the encrypted content may be decoded by using the decryption key or reproduced to provide the content to the content user.

According to another aspect of the present invention, there is provided an apparatus for securely distributing digital content, the apparatus comprising a content provider providing a content distributor with encrypted content, and membership list information of users who have a right of use of the content. The content distributor comprises a content server managing the encrypted content; a membership management server managing the membership list information received from the content provider; and a communication server determining whether the encrypted content is to be provided to a user who requests the content, based on the membership list information received from the content provider, and providing the user with information to allow the user to be connected to the content server so as to use the encrypted content.

The apparatus may further comprise a user terminal accessing the encrypted content based on the information received from the communication server, decrypting the encrypted content, and providing the content to the user who requests the content.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a flowchart illustrating a method of securely distributing digital content according to an embodiment of the present invention;

FIG. 2 is a diagram of a telecommunication network to which a content provider, a content distributor, and a terminal of a content user are applied, according to an embodiment of the present invention;

FIG. 3 is a block diagram of a content provider according to an embodiment of the present invention;

FIG. 4 is a diagram illustrating a method of efficiently managing a list of content users according to an embodiment of the present invention;

FIG. 5 is a diagram illustrating a node in a membership list data structure according to an embodiment of the present invention;

FIG. 6 is a block diagram of a content server according to an embodiment of the present invention;

FIG. 7 is a block diagram of a membership management server according to an embodiment of the present invention;

FIG. 8 is a block diagram of a communication server according to an embodiment of the present invention; and

FIG. 9 is a block diagram of a user terminal according to an embodiment of the present invention.

### DETAILED DESCRIPTION OF THE INVENTION

Hereinafter, exemplary embodiments of the present invention will be described in detail with reference to the accompanying drawings.

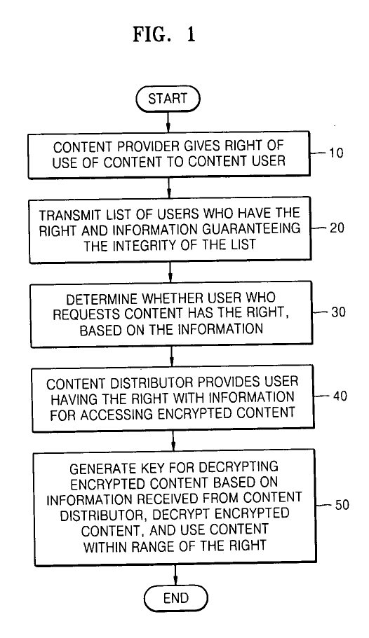

FIG. 1 is a flowchart illustrating a method of securely distributing digital content according to an embodiment of the present invention. Referring to FIG. 1, in operation 10, a right of use of content is given to a content user by providing the content user with information containing an initial value to be used to generate a key for encrypting or decrypting the content. In operation 20, a list of users who have a right of use of the content, and data that contains information guaranteeing the integrity of the list are generated. In operation 30, when the content user requests the content, whether the content user has a right of use of the content is determined based on the list of the users and the information guaranteeing the integrity of the list. In operation 40, when it is determined that the content user has a right of use of the content, encrypted content and information for accessing the encrypted content are transmitted to the content user.

Next, in operation 50, a key for decrypting the encrypted content is generated and the encrypted content is decrypted using the key in the content user's terminal corresponding to unique information of the content user, based on the transmitted information and the initial value; and the content is used within the range of the right of use of the content given to the content user.

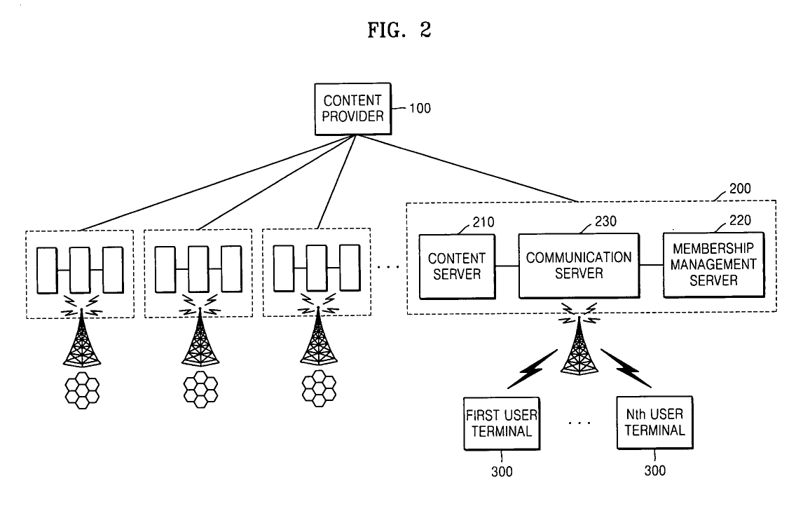

FIG. 2 is a diagram of a telecommunication network to which a content provider 100, a content distributor 200, and a user terminal 300 of a content user are applied, according to an embodiment of the present invention. Here, it is assumed that the content distributor 100 is a mobile telecommunication network business body. In general, a mobile telecommunication network includes distributed system equipment that allows access of users who use mobile telecommunication terminals without respect to place and time and provides fast and effectively services. Also, content can be distributed via the mobile telecommunication network via wireless. Therefore, the mobile telecommunication network is adopted to describe the technical construction and effects of the present invention.

The content provider 100 provides the content distributor 200 with content, membership information of users who have a right of use of the content, and information for allowing each user to use the content.

The content distributor 200 includes a content server 210, a membership management server 220, and a communication server 230 in the telecommunication network, and supports content users so that they can fast and efficiently access the content via wireless. The content server 210 manages encrypted content. The membership management server 220 manages a membership list received from the content provider 100. The communication server 230 is connected to the content server 210 and the membership management server 220 to determine whether the content will be provided to a user who requests the content, and provides the user with information needed to access the content server 220 to use the content.

The content user accesses the encrypted content via the user terminal 300, based on the information received from the content distributor 200, decrypts the encrypted content, and uses the content.

The content server 210, the membership management server 220, and the communication server 230, which are software modules installed into a terminal of the mobile communication network business body, can be separately or integrally used. That is, the types of system devices established in an embodiment of the present invention are not limited.

The content provider 100 allocates a right of use of the content to the user terminal 300. In this case, the content provider 100 and the user terminal 300 share the following information. A method of sharing information between the content provider 100 and the user terminal 300 is not limited. That is, information may be shared between the content provider 100 and the user terminal 300 by using a web service security method that allows an end-to-end security communication, a security telecommunication channel such as a Secure Socket Layer (SSL), or a hardware/software method in an offline state.
One-Way Hash Functions: k=h₁(x,y), z=h₂(x,y)
Initial Value: x₀
Public Key Information of Content Provider: CP_{PublicKey}

The one-way hash functions k=h₁(x,y), z=h₂(x,y), and the public key information CP_{PublicKey}, except the initial value of x₀, may be disclosed to a third party.

The one-way hash function h₁ is used to generate a key k for encrypting/decrypting content. A content user generates a key Kᵢ in an i^{th} session by using the following:
kᵢ=h₁(kᵢ₋₁,yᵢ₋₁)=h₁(h₁ . . . h₁(h₁(h₁(x₀,y₀),y₁),y₂), . . . , yᵢ₋₂)yᵢ₋₁)
That is,
k₁=h₁(x₀,y₀), k₂=h₁(k₁,y₁), . . . , kᵢ=h₁(kᵢ₋₁,yᵢ₋₁) (1),
wherein x₀ denotes the above initial value input to the one-way hash function h₁, yᵢ denotes a value transmitted from the content distributor 200 to the user terminal 300 in operation 40 which will later be described in greater detail.

The one-way hash function h₂ is used to securely manage the membership, and is not influenced by the order in which values are input (commutative characteristics), as expressed in the following equation:
z=h₂(x,y)=h₂(y,x) (2)

An example of the one-way hash function h₂ having the commutative characteristics is given by:
z=h(x,y)=h(min{x,y}, max{x,y}) (3)

The initial value x₀ is used as an initial value to be input to the one-way hash function h₁ in order to generate an encryption/decryption key.

If the initial value x₀ contains intrinsic hardware information regarding the user terminal 300, the content can be used only in a specific terminal storing the intrinsic hardware information. If the initial value x₀ is selected based on information stored in a Subscriber Identity Module (SIM) card of the content user, only a user who has the SIM card can use the content. Also, if the initial value x₀ is generated to be associated with unique terminal number given to a user (a mobile telecommunication number, etc.), the content can be used only in a terminal corresponding to the unique terminal number.

Thus, the initial value x₀ may be determined according to the field of application, that is, it is not limited.

The content provider 100 provides the content distributor with a list of users who have a right of use of the content, and information guaranteeing the integrity of the list, thereby enabling the content provider 100 and the content distributor 200 to share the following information. Similarly, a method of sharing information between the content provider 100 and the content distributor 200 is not limited.
One-Way Hash Function: z=h₂(x,y)
Public Key Information of Content Provider: CP_{PublicKey}
User List: Setᵤₛₑᵣₛ={x₁, x₂, . . . , xₙ}
Information to be Transmitted to each User: Set_{∞}={y₁, y₂, . . . , yₙ}, wherein yᵢ denotes information to be repeatedly transmitted to a user xᵢ
Digital Signature Information Guaranteeing the Integrity of User List: Sign_{CP}_{_{PrivateKey}} (z, t), z, t

The public key information of the content provider 100 is provided as data needed to generate a content decryption key to be transmitted to an individual user.

In the digital signature information, z denotes an input value that is to be signed using a private key CP_{PrivateKey} of the content provider 100, collectively reflects information regarding the list of the users, and is obtained by computing the one-way hash function h₂ by the content provider 100; and t denotes a time stamp value. The time stamp value t may also be used to generate usage control data that specifies a time limit of the content.

That the integrity of the list of the users is guaranteed, means that the list is not changed by a malicious attacker.

FIG. 3 is a block diagram of the content provider 100 illustrated in FIG. 2, according to an embodiment of the present invention. The content provider 100 includes a membership management unit 110 that manages a list of users who have a right of use of content, a user storage unit 120 that stores information regarding content users, a content management unit that encrypts and manages the content, a content storage unit 140 that stores the original content, and a communication unit 150 that establishes communications with a content distributor 200.

The membership management unit 110 generates and stores a membership list data structure of all of the users stored the user storage unit 120 in a memory unit (not shown in FIG. 1), generates information guaranteeing the integrity of a membership list, based on the generated data structure, and transmits the membership list and the information to the membership management server 220 of the content distributor 200 via the communication unit 150.

The user storage unit 120 is a module that stores information regarding the users who have a right of use of the content in or reads it from a database or a file, and manages the type and usage control information of content (a time limit, a number of times that the content can be printed, etc.), and personal information regarding the users.

The content management unit 130 encrypts the original content stored in the content storage unit 140 by using a key of an individual user or a key allocated to a group of users, and transmits the encrypted content to the content server 210 of the content distributor 200 via the communication unit 150.

The communication unit 150 allows secret information or encrypted content to be transmitted to the content distributor 200 via an additional security module (a security communication channel, etc.) by using a web service security method (ws-security, the SSL, etc.).

A skip list data structure will be now briefly described to explain a method of generating a membership list data structure by the membership management unit 110.

Similarly to a tree-type data structure (a binary tree data structure, a binary B-tree data structure, etc.), the skip list data structure provides a method or an algorithm of fast detecting and changing (deleting, registering, or modifying) a specific member from among a set of members that are constructed using the skip list data structure.

The details of the skip list data structure have been introduced by William Pugh [“Skip Lists: A Probabilistic Alternative to Balanced Tree”, Communications of the ACM, 33 (6): pages 668-676, 1990].

In an embodiment of the present invention, the skip lists data structure may be replaced with another data structure that satisfies the purpose of the present invention, that is, the type of a data structure is not limited. However, when another data structure is used, a replacement or a modification of the data structure may be needed to achieve the purpose of the present invention, which is considered as being obvious to those of ordinary skill in the art and thus will not be described here.

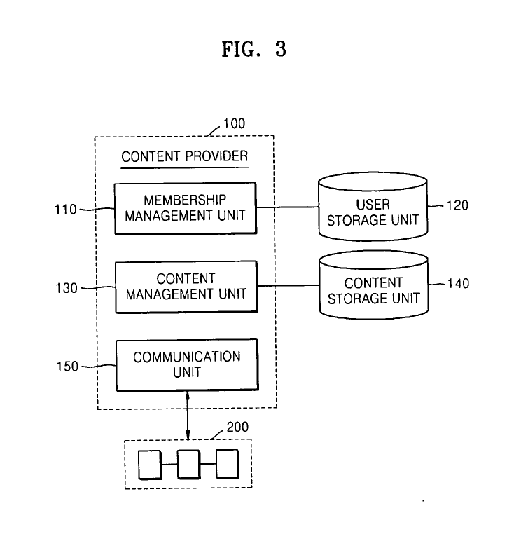

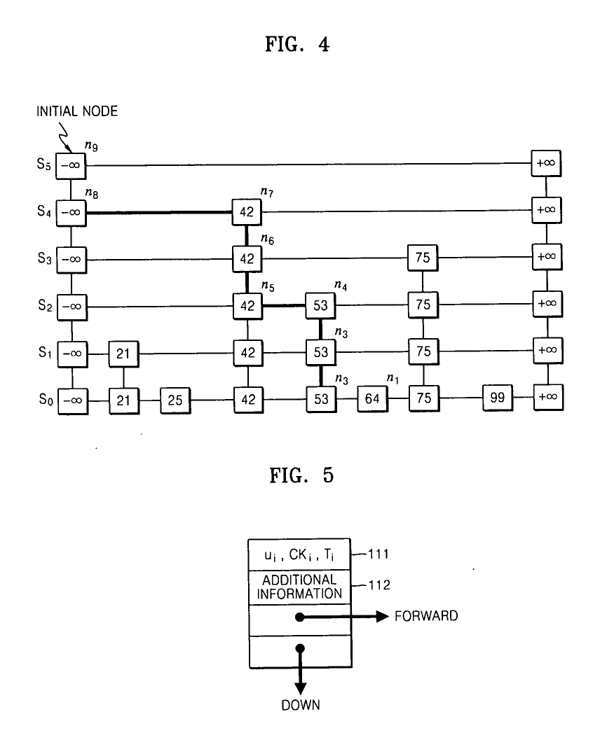

FIG. 4 is a diagram illustrating a method of efficiently managing a list of content users according to an embodiment of the present invention. In detail, FIG. 4 is a diagram of a skip list data structure that is constructed using a set of members {21, 25, 42, 53, 64, 75, 99}.

Referring to FIG. 4, initial and end nodes of each of the skip lists have a value of −∞ and a value of +∞, respectively. The first and last nodes of each skip list do not contain unique member information but are added to simplify an algorithm.

As introduced by William Pugh, members must first be arranged to construct the skip lists. That is, unique values representing the order of arrangement must be respectively given to members, i.e., users who have a right of use of content, so that the members can be arranged.

For convenience of explanation, it is assumed that a unique value allocated to each member is the number of a terminal of a mobile communication network user. Assuming that the terminal numbers of the users who have a right of use of the content are 21, 25, . . . , 99, respectively, as illustrated in FIG. 4, nodes n₉, n₈, . . . , n₁ are visited to determine whether a user having a terminal number of 64 is included in a list of the members by using the flowing search pseudo algorithm.

Search(x):

n [symbol] InitialNode

while(n≠NULL and element(n)<x)

if element(right(n))>x then

n [symbol] down(n)

else

n [symbol] right(n)

endif

endwhile

return element(n) ?

= x

In the above algorithm, right(n) denotes a node present on the right side of the node n, down(n) denotes a node below the node n, and element(n) denotes the value of the node n (the terminal number of a user, as described above).

A method of generating a membership list data structure and detecting a specific member from the membership list data structure by the membership management unit 110 has been described above.

A method of generating information that guarantees the integrity of a membership list based on the generated data structure will now be described with reference to FIGS. 4 and 5.

FIG. 5 is a diagram illustrating a node in a membership list data structure according to an embodiment of the present invention. The membership list is substantially the same as a list of users who have a right of use of content.

Each node contains information regarding a member (an individual content user). The information includes an information field 111 that records a unique number Uᵢ of the member, an input value CKᵢ for generating a key, and content usage control information Tᵢ of a user, and an additional information field 112 regarding the member.

The unique number Uᵢ is identical to a user's terminal number. The input value CKᵢ, which is used to generate a key, is used as an input value to be input to the one-way hash function h₁. The content usage control information Tᵢ is the content usage control information (a time limit for content, etc.) that can be used with the generated key. The content usage control information Tᵢ is used to exactly control use of the content in a content viewer of the user terminal 300 which will later be described.

The additional information field 112 is used to provide private services to a member, or generate another additional security system, e.g., additional information for generating a key or information for changing a key generation function. It is considered that the additional information field 112 is well known in the art, and thus, a description thereof will be omitted.

Information that guarantees the integrity of a membership list based on the above data structure is generated by obtaining a value h(z,timestamp) by performing a hash operation on z=f(RootNode) computed from the definition of the following function f(n), and a time value when the z=f(RootNode) is computed, and then signing h(z,timestamp) using a private key CP_{PrivateKey} of the content provider 100 using the hash function h₂ and the information field 111.

RootNode denotes the initial node illustrated in FIG. 4, and h denotes a general hash function such as the one-way hash function h₁ or h₂.

The function f(n) is defined as follows:

$$if r = NULL then f ( n ) = 0$$

$$if d = NULL and up ( r ) \neq NULL then f ( n ) = {h}_{2} ( e ( n ) , e ( r ) )$$

$$if d = NULL and up ( r ) = NULL then f ( n ) = {h}_{2} ( e ( n ) , f ( r ) )$$

$$if d \neq NULL and up ( r ) \neq NULL then f ( n ) = f ( d )$$

$$if d \neq NULL and up ( r ) = NULL then f ( n ) = {h}_{2} ( f ( d ) , f ( r ) )$$

In the above definition, r denotes a node right(n) present on the right side of a node n, d denotes a node down(n) below the node n, and e(n) denotes Uᵢ×CKᵢ×Tᵢ. up(r) denotes a node above a node r. From the construction of the node illustrated in FIG. 5, it is not easy to determine whether up(r)≈NULL. To calculate up(r)≈NULL, additional pointer pointing to an upper node can be used.

If the existing user is deleted from or modified in a user information-based membership list data structure or a new user is registered with the data structure, the data structure is changed by using an algorithm for modifying skip lists, information that guarantees the integrity of the skip lists based on the changed data structure is generated as described above, and then, information regarding the added, changed, or deleted user and the information are transmitted to the membership management server 220 of the content distributor 200.

Upon receiving the membership list data structure and the information that guarantees the integrity of the skip lists, the membership management server 220 can manage a membership list based on the received data structure and information.

The membership management server 220 may need information used to generate the skip lists so as to generate the above membership list data structure. For instance, the information needed may describe the level of each member, e.g., the level of a member node having a value of 53 is 3 and the level of a member node having a value of 64 is 1 (see FIG. 4). The information is needed when using a skip list data structure, and another type of information may be needed when using another data structure.

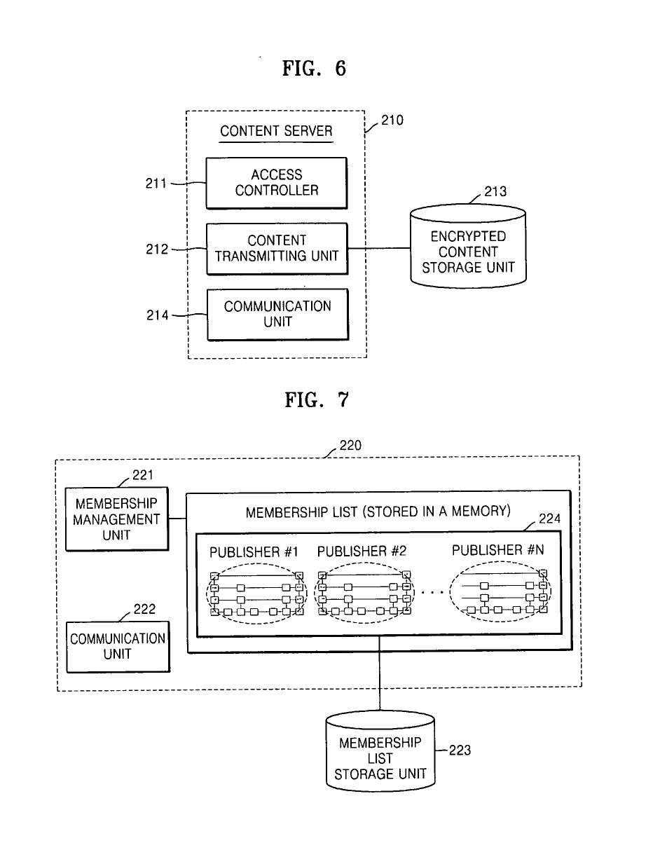

FIG. 6 is a block diagram of the content server 210 of FIG. 2 according to an embodiment of the present invention. Referring to FIG. 6, the content server 210 includes an access controller 211 that controls content access, a content storage unit 213 that stores encrypted content, a content transmitter 212 that efficiently transmits the content stored in the content storage unit 213 to a user, and a communication unit 214 that establishes communications with a content provider or a specific server of a content distributor.

The access controller 211 is a module that controls a user's content access according to an additional content distribution policy of the content distributor by charging the user for use of the content or placing restrictions on the user's content access based on the user's credit standing or identity (depending on whether the user is a juvenile or an adult, for example). For example, even if a user is included in a list of content users received from the content provider 100, the access controller 211 does not temporarily permit the user's access to the content when the user does not complete payment for use of the content.

The content transmitter 212 is a module that efficiently transmits encrypted content to a content user. In this case, various methods of transmitting the encrypted content may be used according to the type of the content (music, video, a text, etc.), the content size, or a network construction of the content distributor 200. In the present invention, a method of transmitting content is not limited.

In general, the content storage unit 213 stores and manages a medium or large-scale of encrypted content by using a database. If content is a text which is small-sized content, the content storage unit 213 may manage the content in its memory without storing the content in a file, etc.

The communication unit 214 communicates with the content provider 100 or a specific server of the content distributor 200 to register encrypted content or receive information regarding a user who requests content.

FIG. 7 is a block diagram of the member management server 220 of FIG. 2 according to an embodiment of the present invention. Referring to FIG. 7, the membership management server 220 includes a membership management unit 221 that manages information regarding content users received from the content provider 100 of FIG. 2, a communication unit 222 that exchanges information with the communication server 230 or the system of the content provider 100, and a membership list backup storage unit 223.

The membership management unit 221 processes information to respond to a question “Is a specific user included in a membership list of a specific content provider?”, given from the communication server 230, based on its own membership information, and transmits the processing result to the communication server 230. If there are a plurality of content providers, the membership management unit 221 is capable of efficiently managing a plurality of membership lists 224.

The communication unit 222 is connected to the system of the content provider 100 or the communication server 230 to receive membership information or informs the result of membership verification in response to a request therefor.

The membership list backup storage unit 223 stores a membership list data structure, which is stored in a memory, in a database or a file so that the same membership list data structure can be maintained even if the member management server 220 is interrupted and driven again.

When the content distributor 200 performs operation 30, illustrated in FIG. 1, in which whether a user u who requests content has a right of use of the content is determined based on a membership list and information that guarantees the integrity of the membership list, the membership management unit 221 can easily compute whether the user u is included in the membership list within a length of time O(log n), using an algorithm search (u) for searching for skip lists.

To achieve the purpose of the present invention, i.e., to distribute content exactly to only a designated content user even if the content distributor 200 is an unreliable intermediary, it is required to provide the communication server 230 with information proving that a searched membership list is not modified by a malicious attacker. The following is a pseudo algorithm that provides such information:

r₁ [symbol] right(n₁)
if up(r₁)=NULL then

q₀ [symbol] f(r₁)

else

q₀ [symbol] e(r₁)

end if

q₀ [symbol] e(r₁)

q₁ [symbol] e(u) (if u is not a member (search is failed): q₁ [symbol] e (a largest one of
members less than u )
k [symbol] 1

for i [symbol] 2, ..., m−1 do

rᵢ [symbol] right(nᵢ)

if up(rᵢ)=NULL then

k [symbol] k+1

if rᵢ≠nᵢ₋₁ then

qₖ [symbol] f(r₁)

else

if nᵢεS₀ then

qₖ [symbol] e(n₁)

else

qₖ [symbol] f(down(nᵢ))

end if
end if
end if
end for

Prior to performing the pseudo algorithm, a set of nodes visited during the determination as to whether the user u is included in the membership list are rearranged in the reverse order in which they are invited, and then defined as {n₁, n₂, . . . , nₘ}. Referring to FIG. 4, the set of the nodes is defined as {n₁, n₂, . . . , n₉}. A set of nodes generated according to the pseudo algorithm is defined as Q(u)={q₀, q₁, . . . , nₖ}.

The set Q(u) is used to verify the integrity of the membership list, and the use thereof will be clarified from the following that is an example of the construction of the communication server 230. In the above pseudo algorithm, S₀ denotes a list of all of members of the data structure of a skip list illustrated as a last line in FIG. 4.

The value of a function f(x) for each node is computed only once and recorded in an additional information field 112 illustrated in FIG. 5, thereby removing a need to compute the value whenever an algorithm is executed.

In the above pseudo algorithm, nodes invited during execution of a search algorithm are recorded in a stack data structure, and thus, those of ordinary skill in the art can easily embody the algorithm.

Therefore, if the determination as to whether the user u is included in the membership list is true, the set Q(u) is transmitted to the communication server 230 via the membership management unit 221, together with the information u, CK, and T regarding the node. Otherwise, the following information is provided:

$$if up ( 4 ) \neq NULL then return Q ( u )$$

$$f up ( r ) = NULL and up ( rr ) \neq NULL then return element ( rr ) , \\ element ( r ) , \\ Q ( u )$$

$$if up ( r ) = NULL and up ( rr ) = NULL then return f ( rr ) , \\ element ( r ) , \\ Q ( u )$$

In the above information, r denotes a node right(u) present on the right side of a node n. Since the member u, which is an actual object to be searched for, is not a member of a set Setᵤₛₑᵣₛ, rr denotes the node right(r). Here, u denotes a largest member less than a member to be searched for from the set Setᵤₛₑᵣₛ. Element(n) denotes information u, CK, and T of the node n. As described above, the above information is needed to reflect information regarding all of members of the member list during the computation of z.

The above information, which is provided when the determination as to whether the user u is included in the membership list is false, is used to determine whether the set Q(u) is correct, that is, to determine whether a first member value of the set Q(u) is changed. The above definition of the function f(n) clarifies the reason that the above information is needed.

Referring to FIG. 4, the search results whether a member having a unique value of 64 is included in the member list are u, CK, and T of the node 64, and a set {e(right(n₁)), e(n₁), e(n₂), f(down(n₅)), f(right(n₆)), f(down(n₈))}, and the search results about a member having a unique value of 60, which is not included in the member list, are the element 75, the element 64, and a set {f(n₁), e(n₂), e(n₂), f(down(n₅)), f(right(n₆)), f(down(n₈))}.

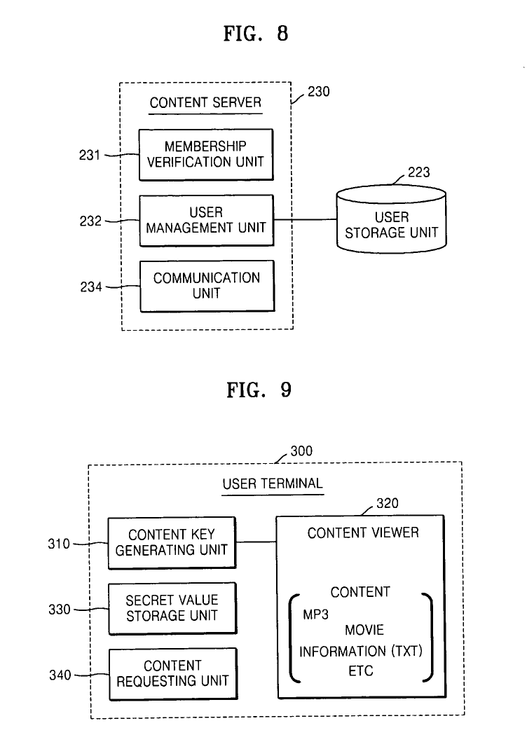

FIG. 8 is a block diagram of a communication server 230 according to an embodiment of the present invention. The communication server 230 includes a membership verification unit 231 that finally verifies the membership of a specific user based on membership information of the specific user received from the membership management server 220, a user management unit 232 that obtains information regarding a user who requests content from the user storage unit 233 that stores personal information regarding users of the content distributor 200 (mobile telecommunication users in a specific mobile telecommunication network) and information for user management, and a communication unit 234 that is connected to a content user, a content server, and a membership management server 220 to exchange information with them.

The membership verification unit 231 transmits a unique number uᵢ of the user who requests the content to the membership management server 220 so as to request verification as to whether the user is included in the member list received from the content provider 100 that provides the content.

The unique number uᵢ of the user may be the number of a mobile telephone which is a terminal of the user, or a user identification number, obtained from the user storage unit 233, which is predetermined to distinguish the user from the content provider 100.

As described above, the membership verification unit 231 receives the processing result (the result of performing operation 30, and Q(x) or e(rr), e(r),Q(x)) and z=h₂(h₂( . . . h₂(V,q₂), . . . . )qₖ₋₁, qₖ) from the membership management unit 221 of the membership management server 220 (V is q₁ or h₂(h₂(e(rr)),e(r),q₁) according to the processing result); or computes z=h₂(h₂(f(rr),e(r),q₁)); determines whether the computing result z is equal to the input value z signed by the content provider 100, and determines whether the user who requests the content is included in the membership list.

The input value z is acquired in operation 20 of the method of FIG. 1, and the timestamp t is also checked when it is determined whether the computing result z is equal to the input value z.

If the computing result 1 is not equal to the input value z, that is, if the original member list is changed without an authority, the original membership list is received again from the content provider 100 and registered with the membership management server 220.

If it is determined that the user who requests the content has a right of use of the content, the information guaranteeing the integrity of the membership list, the information for accessing the content, and the information u, CK, and T are transmitted to the user (a terminal of the user). If not so, the request of the user is rejected.

Operation 30 in which the content distributor 200 determines whether the user who requests the content has a right of use of the content, based on the membership list and the information that guarantees the integrity of the membership list, and operation 40 in which the content distributor provides the user who has a right of use of the content with information for accessing encrypted content registered with the content distributor 200 by the content provider 100, have been described above.

Operation 50 in which the content user generates a key for decrypting the encrypted content, decrypts the encrypted content by using the key, and uses the content within the range of the right of use of the content, allowed to the user, will now be described in detail.

FIG. 9 is a block diagram of the user terminal 300, illustrated in FIG. 2, according to an embodiment of the present invention. The user terminal 300 includes a content key generating unit 310 that generates a key for decrypting encrypted content; a content viewer 320 that decrypts the encrypted content and allows the user to use the content within the range of the right to use the content, given to the user; a secret value storage unit 330 that manages secret information to be shared with the content provider 100, which is set in operation 10 of the method of FIG. 1, and a content requesting unit 340 that is used to receive the encrypted content.

The content key generating unit 310 receives the input value CK transmitted in the operation 40 of the method of FIG. 1 and a previous content key, and generates a content key by using the following:
Keyᵢ=hᵢ(Keyᵢ₋₁, CK) (4)

Equation (4) does not limit the operation of the content key generating unit 310 but exemplifies it. That is, information other than the previous content key and the information CK may be used to generate the content key, and the content key may be generated using another method. For example, if entropy, which is too small to be used as a key, is obtained by using the hash function h₁, the hash function h₁ needs to be supplemented and/or extended.

The secret value storage unit 330 is a module that securely manages an initial value x₀ defined to generate the content key. The secret value storing unit 330 may be a hardware device, such as a smart card, which provides the temper-resistant characteristic, or a software device. The type of the secret value storing unit 330 is not limited.

The content requesting unit 340 fetches the content from the user terminal 300, using the information for accessing the content, which is received from the communication server 230. A method of fetching the content to the user terminal 300 may be selected according to the type and size of the content and a network construction of the content distributor 200.

The content viewer 320 determines whether the key generated by the content key generating unit 310 is given to a user who has a right to use the content, based on the information received from the communication server 230, decrypts the encrypted content provided from the content requesting unit 340 by using the generated key, and provides the content to the user. For example, assuming that a unique number u that the communication server 230 allocates to the user is a mobile communication number, it is determined whether the unique number u is the same as the mobile communication number of the user terminal 300. In this case, whether the unique number u is illegally modified may be determined by using an equation that allows the communication server 230 to determine whether the membership list is illegally changed.

In an embodiment of the present invention, the usage control information T of the content received from the communication server 230 is used to allow the content viewer 320 to precisely control the user's right to use the content. In an embodiment of the present invention, the usage control information T may specify the usage of the content (printing, copying, changing, or modifying of the content). For example, the usage control information T may be a hash value of an eXtensible Markup Language (XML) document, and the XML document may describe constraints on the usage of the content in detail.

In this disclosure, a method of providing a separate key to each content user, according to an embodiment of the present invention, has been described. If the same content is provided to a large number of users, the content must be encrypted using a separate content key allocated to an individual user.

This problem may be solved as follows. First, the users are categorized according to groups, and the same initial value x₀ for generating a key and the same information CK for generating the content key are provided to users belonging to the same group.

Second, the above content key is used as an authentication key when a content server authenticates a content user, and the content key is transmitted to only an authenticated user via a secret communication channel.

Third, a group key-based algorithm, and a modification of some of the methods established in the present invention are used.

It would be apparent to those of ordinary skill in the art that each operation of the methods according to embodiments of the present invention can be variously embodied in a software or hardware manner, using a general programming method.

Also, some of the operations of the methods can be embodied as computer readable code in a computer readable medium. The computer readable medium may be any recording apparatus capable of storing data that is read by a computer system, e.g., a read-only memory (ROM), a random access memory (RAM), a compact disc (CD)-ROM, a CD-rewritable (RW), a magnetic tape, a floppy disk, a hard disc drive, an optical disc, a magneto-optical storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

According to the present invention, information containing an initial value for generating a key for encrypting or decrypting content is provided to a content user so that the content user can have a right to use the content; a list of users who have a right to use the content and data guaranteeing the integrity of the list are generated; when a user requests the content, it is authenticated whether the user has a right to use the content, based on the list and the information guaranteeing the list; and encrypted content and information for accessing the content are transmitted to the authorized user, thereby securely transmitting the content to only the authorized user irrespective of the reliability of a content distributor and allowing the user to efficiently use the content.

The list of the users who have a right to use the content, which a content provider transmits to the content distributor, cannot be changed without a help of the content provider. The content user can efficiently use encrypted content with a help of the content distributor without contacting the content provider content distributor. The content distributor cannot read and modify the content by using only information received from the content provider. Further, a right of use of the content, which is given to the content user, can be finely controlled in a terminal of the user according to the type of content. For example, it is possible to control a time limit for the content, and copying and printing of the content.

Also, if an illegal third party changes the list of content users, e.g., if it deletes a user having a right of use of the content from the list or adds a user having no right of use of the content to the list, such an illegal change of the list is easily recognized in real time, thereby securely protecting the list.

Accordingly, according to the present invention, it is possible to securely distribute and use digital content, which has been widely spread, regardless of a content distributor.

While this invention has been particularly shown and described with reference to exemplary embodiments thereof, it will be understood by those skilled in the art that various changes in form and details may be made therein without departing from the spirit and scope of the invention as defined by the appended claims. For example, in this disclosure, the Internet or a mobile telecommunication network are exemplified as examples of a telecommunication network. However, the telecommunication network may be a public switched telephone network (PSTN).

What is claimed is:

1. A method of securely distributing digital content, comprising:
(a) giving a right of use of the content to a content user by providing the user with information which contains an initial value for encrypting or decrypting the content;
(b) generating data which includes a list of users who have a right of use of the content and information guaranteeing the integrity of the list;
(c) when the content user request the content, determining whether the content user is an authorized user who has a right of use of the content, based on the list and the information guaranteeing the integrity of the list; and
(d) when it is determined that the content user is an authorized user, providing the content user with encrypted content and information for accessing the encrypted content.

2. The method of claim 1, wherein during (a), a right of use of the content is given to the content user by providing the content user with a first function used to generate a key for encrypting or decrypting the content, a second function used to securely manage a membership list listing the users as members, an initial value to be input to the first function, and a public key of a content provider.

3. The method of claim 2, wherein the first function is a one-way hash function, and
the second function is a one-way hash function that determines output values regardless of an order in which input values are input.

4. The method of claim 2, wherein the initial value is determined according to hardware information regarding a terminal that the content user uses to use the content.

5. The method of claim 1, wherein the information generated in (b) comprises:
the list of the users who have a right of use of the content;
data needed to generate a decryption key which is used to decrypt the content and transmitted to an individual user;
usage control data specifying a time limit for the content; and
digital signature information guaranteeing that the list of the users is not changed by a malicious attacker.

6. The method of claim 1, wherein, during (c), whether the content user who requests the content has a right of use of the content is determined based on the list of the content users, and
whether the determination result is obtained based on the list of the users is determined using the information guaranteeing the integrity of the list.

7. The method of claim 1, wherein the information transmitted in (d) comprises:
the encrypted content that the content user requests;
data needed to generate a decryption key for decrypting the content;
data specifying constraints on use of the content; and
data containing unique information of the content user.

8. The method of claim 7, further comprising (e) generating the decryption key for decrypting the encrypted content in a terminal, which corresponding to the unique information of the content user, of the content user based on the received information and the initial value for encrypting or decrypting the content, decrypting the encrypted content, and allowing the content user to use the decrypted content within a range of the right of use of the content given to the content user.

9. The method of claim 8, wherein, during (e), the decryption key is generated by using the received data needed to generate the key for decrypting the encrypted content, and
the content is provided to the content user by using the decryption key and the encrypted content according to the constraints within the range of the right of use of the content.

10. The method of claim 8, wherein, during (e), only when the terminal of the content user corresponds to the unique number of the content user, the decryption key is generated, and
the encrypted content is decoded by using the decryption key, or reproduced to provide the content to the content user.

11. A method of securely distributing digital content, comprising:
(a) a content provider providing a content user with a right of use of the content by transmitting information containing an initial value for encrypting or decrypting the content to the content user;
(b) the content provider generating data which contains a list of users who have a right of use of the content and information guaranteeing the integrity of the list, and transmitting the data to the content distributor;
(c) when the content user requests the content, the content distributor determining whether the content user is an authorized user who has a right of use of the content, based on the list and the information guaranteeing the list; and
(d) when it is determined that the content user is an authorized user, the content distributor transmitting information for accessing encrypted content to the content user, the information being registered with the content distributor by the content provider.

12. The method of claim 11, wherein during (a), a right of use of the content is given to the content user by providing the content user with a first function for generating a key to be used to encrypt or decrypt the content, a second function for securely managing a membership list of the users, an initial value to be input to the first function, and a public key of a content provider.

13. The method of claim 12, wherein the first function is a one-way hash function, and
the second function is a one-way hash function that determines output values regardless of an order in which input values are input.

14. The method of claim 12, wherein the initial value is determined according to hardware information regarding a terminal that the content user uses to use the content.

15. The method of claim 11, wherein the information generated in (b) comprises:
the list of the users who have a right of use of the content;
data needed to generate a decryption key which is used to decrypt the content and transmitted to an individual user;
usage control data specifying a time limit for the content; and
digital signature information guaranteeing that the list of the users is not changed by a malicious attacker.

16. The method of claim 11, wherein, during (c), whether the content user who requests the content has a right of use of the content is determined based on the list of the content users, and
whether the determination result is obtained based on the list of the users is determined using the information guaranteeing the integrity of the list.

17. The method of claim 11, wherein the information transmitted in (d) comprises:
the encrypted content that the content user requests;
data needed to generate a decryption key for decrypting the content;
data specifying constraints on use of the content; and
data containing unique information of the content user.

18. The method of claim 17, further comprising (e) generating the decryption key for decrypting the encrypted content in a terminal, which corresponds to the unique information of the content user, of the content user based on the received information and the initial value for encrypting or decrypting the content, decrypting the encrypted content, and allowing the content user to use the decrypted content within a range of the right of use of the content given to the content user.

19. The method of claim 18, wherein, during (e), the decryption key is generated by using the received data needed to generate the key for decrypting the encrypted content, and
the content is provided to the content user by using the decryption key and the encrypted content according to the constraints within the range of the right of use of the content.

20. The method of claim 18, wherein, during (e), only when the terminal of the content user corresponds to the unique number of the content user, the decryption key is generated, and
the encrypted content is decoded by using the decryption key, or reproduced to provide the content to the content user.

21. An apparatus for securely distributing digital content, comprising:
a content provider providing a content distributor with encrypted content, and membership list information of users who have a right of use of the content; and
a content distributor comprising:
a content server managing the encrypted content;
a membership management server managing the membership list information received from the content provider; and
a communication server determining whether the encrypted content is to be provided to a user who requests the content, based on the membership list information received from the content provider, and providing the user with information to allow the user to be connected to the content server so as to use the encrypted content.

22. The apparatus of claim 21, wherein the content provider comprises:
a membership management unit managing a list of content users;
a user storage unit storing information regarding the content users;
a content management unit encrypting and managing the content; and
a content storage unit storing the original content.

23. The apparatus of claim 21, wherein the content server comprises:
an access controller controlling user access to the content;
a content storage unit storing the encrypted content; and
a content transmitting unit transmitting the encrypted content stored in the content storage unit to the users.

24. The apparatus of claim 21, wherein the membership management server comprises:
a membership management unit managing content user information received from the content provider; and
a membership list backup storage unit storing a membership list in a file or a database system.

25. The apparatus of claim 21, wherein the communication server comprises:
a membership verification unit finally verifying membership of the user based on specific membership information of the user received from the membership management server;
a user storage unit storing data which contains personal information regarding the users and information for user management; and
a user management unit collecting a unique number of the user who requests the content and data needed to control user access of the content, from the user storage unit.

26. The apparatus of claim 21, further comprising a user terminal accessing the encrypted content based on the information received from the communication server, decrypting the encrypted content, and providing the content to the user who requests the content.

27. The apparatus of claim 26, wherein the user terminal comprises:
a content key generating unit generating a decryption key for decrypting the encrypted content;
a secret value storage unit managing secret information if the content provider provides the secret information;
a content requesting unit used to receive the encrypted content; and
a content viewer decrypting the content and allowing the user who requests the content to use the content within a range of a right of use of the content given to the user.
